(19) United States
(12) Patent Application Publication
(10) Pub. No.: US 2023/0343194 A1
(43) Pub. Date: Oct. 26, 2023

(54) VEHICLE, SYSTEM AND METHOD USING A VANDALISM DETECTION DEVICE

(71) Applicant: BODE - DIE TÜR GMBH, Kassel (DE)

(72) Inventors: Guido BACHMANN, Guxhagen (DE); Markus HERMANN, Immenhausen (DE)

(21) Appl. No.: 18/254,311

(22) PCT Filed: Nov. 23, 2021
(86) PCT No.: PCT/EP2021/082667

§ 371 Date: May 24, 2023

(30) Foreign Application Priority Data
Nov. 24, 2020 (DE) 10 2020 131 120.6

(51) Int. Cl. G08B 13/196; E05F 15/40

(52) U.S. Cl. CPC G08B 13/19647; G08B 13/19697; E05F 15/40; E05Y 2400/54; E05Y 2900/506; E05Y 2900/531

(57) ABSTRACT

A vehicle includes sensors that monitor at least part of the outer shell of the vehicle. The sensors have monitoring sensors for detecting vandalism. The vehicle has a monitoring system using the monitoring sensors and the monitoring system includes monitoring sensor electronics which are set up to operate the monitoring sensors at least also in the parked state of the vehicle. The vehicle includes automatically closing doors and the sensors have operating sensors for detecting the position of passengers as well as an entry system using the operating sensors, which serves to detect the position of passengers, in order to prevent a jamming of passengers during the automatic closing of the doors. At least one sensor is configured both as an operating sensor and a monitoring sensor and is used both by the monitoring system and also by the entry system.

### CROSS-REFERENCE TO RELATED APPLICATIONS

This application is a 35 U.S.C. § 371 National Stage patent application of PCT/EP2021/082667, filed on 23 Nov. 2021, which claims the benefit of German patent application 10 2020 131 120.6 filed 24 Nov. 2020, the disclosures of which are incorporated herein by reference in their entirety.

### TECHNICAL FIELD

The disclosure relates to a vehicle with sensors.

### BACKGROUND

Vehicles with sensors are already known. A disadvantage in known vehicles with sensors is that the sensors are often not suitable to fulfil particular monitoring tasks to a desirable extent, and/or the potential of the sensors is not, or can not be, utilized entirely.

Outside operating times, parked vehicles are generally situated on closed, partially monitored areas. Access by unauthorized third parties can, however, only be safeguarded with a correspondingly expensively secured depot. Nevertheless, the operators are regularly confronted with damage to the vehicles in the form of graffiti or destroyed vehicle add-on parts and broken-open entries.

US 2020/001827 A1 shows a vehicle monitoring system in order to obtain identification information from a personal electronic device of a potential intruder as a reaction to a potential theft, vandalism or intrusion into a vehicle, and can be regarded as the closest prior art.

From SE 541 541 C2 a method is known for break-in detection in a vehicle, which comprises the activating of at least one sensor of the vehicle, triggered by a vehicle alarm, the capturing of an image by the sensor and the capturing of a predefined object in the image.

### SUMMARY

The problem addressed by the disclosure relates to providing an improved monitoring system for vehicles, which in particular prevents vandalism and or can serve for the reconnaissance of cases of vandalism. The device is to be able to be produced and used in an economical manner. The problem addressed by the disclosure also relates to providing an improved method for monitoring a vehicle.

This problem is solved by the vehicle claimed in one of the independent claims, the and the method claimed in another of the independent claims.

In the vehicle with sensors according to the disclosure, the sensors monitor at least part of the outer shell of the vehicle.

The disclosure enables the individual monitoring of the outer shell of a vehicle by the latter itself. In the case of parked vehicles, vandalism, graffiti, but also unauthorized access to the vehicles can be detected via the sensors.

Through the individual vehicle monitoring, it is possible to distinctly reduce the costs for vandalism damage and graffiti on the part of the operator. In particular, the elimination of the graffiti paint leads to a damage of the paint layer and of the mounted push-buttons, indicator lights, speakers, etc.

Alarm systems on-board the vehicle, in so far as they are installed, generally monitor the interior of the vehicle. Within investigations for the use of optical, acoustic or radar sensors for use in entry systems of rail vehicles and buses, however, it has become apparent that the sensor system can be used inter alia to realize a monitoring of the outer skin individually for the vehicle under consideration.

The sensors comprise monitoring sensors. Monitoring sensors mean sensors for the detection of vandalism. The monitoring systems are preferably in operation at least also outside the operating times of the vehicle, for instance in the stationary or respectively parked state of the vehicle.

The sensors comprise operating sensors. Operating sensors mean sensors in particular for detecting the position of passengers. The operating sensors are preferably in operation at least also during the operating times of the vehicle.

The vehicle comprises a monitoring system using the monitoring sensors, which in particular prevents vandalism and/or can serve for the reconnaissance of cases of vandalism. The monitoring system is preferably set up to be in operation outside the operating times of the vehicle, for instance in the stationary or respectively parked state of the vehicle. The monitoring system comprises monitoring sensor electronics which are set up to operate the monitoring sensors at least also in the parked state of the vehicle outside the operating times of the vehicle. The vehicle can have an energy storage for the energy supply of the monitoring system in the parked state of the vehicle. In an embodiment, the monitoring sensor electronics are set up to operate the monitoring sensors exclusively outside the operating times of the vehicle.

The monitoring system preferably comprises an activation device which, further preferably, can bring about the undertaking of various measures. Preferably, the activation device is set up to bring about the switching on of cameras and/or the emitting of an audible acoustic alarm or of a silent alarm and/or the switching on of a lighting.

Preferably, each sensor has respectively a detection zone. The detection zone can be two-dimensional or three-dimensional. The outer shell of the vehicle preferably has several areas. It can comprise a front area, a rear area, two lateral areas, an upper area and a lower area or include hereof.

The monitoring sensors—or at least one of the monitoring sensors—have a detection zone which is adapted or adaptable to the outer contour of the outer shell of the vehicle, preferably by the detection zone extending along at least one edge of an area of the outer shell. In this way, a particularly custom-made individual monitoring of the outer shell of the vehicle can take place. Hereby, the monitored region can be reduced to the necessary extent for instance for combatting vandalism. This can reduce false alarms.

The vehicle has doors. Preferably, each door defines a door region. The door region can also be designated as close range of the door and preferably lies outside the vehicle. Preferably, at least one of the monitoring sensors is arranged in an end region of the vehicle, in particular remote from a door or a door region of the vehicle. Preferably, the door region has an extent running horizontally, parallel to a lateral wall of the outer shell of the vehicle. Preferably, the extent of a door region parallel to the lateral area of the outer shell is less than 40% or 20% or 10% of the horizontal extent of the respective lateral area. Preferably, at least one of the sensors has a detection zone which is greater than a door region. The detection zone at least of one of the sensors can also include the door region. The detection zone at least of one of the sensors can extend outside the door region. At least one of the monitoring sensors can have a detection zone which is greater than the door region and which, further preferably, also includes the door region and which particularly preferably is adapted to the outer shell or respectively to the outer contour of the outer shell of the vehicle. At least one of the monitoring sensors can have a detection zone, the shape and size of which corresponds at least approximately to the shape and size of an area of the outer shell of the vehicle. In this way, a particularly custom-made individual monitoring of the outer shell of the vehicle can take place. Detection zones of several monitoring sensors can also be selected so that together they at least approximately cover an area of the outer shell. The detection zones of several monitoring sensors can overlap one another in an overlapping region. Preferably, the monitoring sensors monitor at least one lateral area of the outer shell to a proportion of more than 50% or 60% or 80% or 90%. Preferably, the monitoring sensors monitor at least the two lateral areas of the outer shell.

Through a suitable choice of the detection zone of the sensors, it is also possible to detect a crawling underneath of the vehicles.

Preferably, the monitoring sensors—or at least one of the monitoring sensors—have a detection zone which is configured so that a crawling underneath of the vehicle is detected. Preferably, this detection zone reaches to the ground on which the vehicle is standing. Moreover, this detection zone can be adapted to the outer contour of the vehicle.

The vehicle can be a public transport vehicle or respectively a local public transport vehicle. The vehicle can be a rail vehicle, for example an underground train or a suburban train. The vehicle can be a bus. The vehicle can comprise an electric drive, in particular an electric motor. The vehicle can comprise an energy store for the electric drive. The energy store can be a battery or respectively an accumulator. The energy store can be chargeable by means of charging electronics, in particular by means of a contactless, for example inductive, charging method. The charging electronics can be arranged on the underside of the vehicle or respectively arranged beneath the vehicle during charging. In particular when the monitoring sensors or at least one monitoring sensor has a detection zone, which is configured so that a crawling underneath of the vehicle is detected, this can serve for protecting the charging electronics. In the case of buses with a contactless (inductive) charging method, the sensor system can be used to monitor and protect the charging electronics.

The vehicle has automatically closing doors. The vehicle comprises an entry system, which can also be designated as “Boarding Management Unit” or “BMU”. The entry system serves to detect the position of passengers, in order to prevent a jamming of passengers during the automatic closing of the doors of the vehicle. The entry system can react to gestures of the passengers, it can comprise a gesture control. The entry system comprises or respectively uses the operating sensors or at least one of the operating sensors, in particular for monitoring a door region. The operating sensors are preferably arranged respectively above a door. The entry system can use at least one of the operating sensors for the exclusive monitoring of a door region. The detection zone of this sensor is preferably adapted to the respective door region, at least during use by the entry system. The at least one operating sensor used by the entry system can also be designated as BMU sensor. Preferably, the entry system comprises entry sensor electronics, which are preferably set up to operate at least one of the operating sensors in the operating times of the vehicle.

In an embodiment, the monitoring system uses exclusively additionally installed sensors, therefore sensors installed additionally to the sensors of the entry system. In another embodiment, the monitoring system uses exclusively sensors of the entry system. Preferably, the monitoring system uses sensors of the entry system and sensors installed additionally to the latter. At least one of the sensors is used both by the monitoring system and also by the entry system, therefore is a sensor which is used in a multiple manner. Hereby, in vehicles with an entry system, the additional expenditure which is involved with the monitoring system can be restricted.

In an embodiment the operating sensors are in operation exclusively during the operating times of the vehicle. In another embodiment, the operating sensors are in operation during and outside the operating times of the vehicle. The operating sensors can be sensors which are already present in any case—in particular for the detection of the position of passengers to prevent jamming during the automatic closing of the doors of the vehicle.

The sensors are, or at least one of the sensors is, configured both as operating sensor and also as monitoring sensor, and is used both by the entry system and also by the monitoring system. In an embodiment, the detection zone of this sensor is changeable. Preferably, the monitoring system uses this sensor with a different detection zone than the entry system. Preferably the entry system uses this sensor with a detection zone adapted to the door region. Preferably, the monitoring system uses this sensor with a detection zone adapted to the outer contour of the outer shell of the vehicle.

Alternatively, the detection zone of the at least one sensor, configured both as operating sensor and also as monitoring sensor, is not changeable. It has been found that this is not absolutely necessary, and the monitoring system, for instance in the case of a retrofit, can also use sensors of the entry system without a changeable detection zone.

In the case of oncoming vehicles, interfering contours can be detected (underground train surfers, suburban train surfers or dragged-along objects).

The vehicle preferably comprises an interfering contour detection system which can configure the operation of the vehicle in a more secure manner by, for example, the detecting of interfering contours such as for example of underground train surfers or of suburban train surfers and/or of dragged-along objects being able to be enabled or improved in particular in the case of oncoming vehicles. The interfering contour detection system is preferably set up to be in operation, preferably exclusively, during the operating times of the vehicle. When the sensors used by the interfering contour detection system have a detection zone which is adapted or adaptable to the outer contour of the outer shell of the vehicle, interfering contours can then be detected hereby particularly reliably. Preferably, in the case of vehicles with a monitoring system, the interfering contour detection system uses—preferably exclusively —sensors which are also used by the monitoring system. Hereby, in the case of vehicles with a monitoring system, the additional expenditure which is involved with the interfering contour detection can be restricted.

The problem is solved in particular by a vehicle with sensors on its outer shell, which guarantee a non-imaging detection.

Preferably, the sensors—or at least one of the sensors —guarantee a non-imaging detection. The sensors or at least one of the sensors can be arranged inside the vehicle. Preferably, the sensors do not monitor the interior of the vehicle. Preferably, at least one sensor is embodied as an external sensor. The term “external sensor” designates within this publication in particular a sensor arranged on the vehicle, outside the vehicle.

Preferably, the sensors are—or at least one of the sensors is—arranged externally on the outer shell of the vehicle.

Preferably, the sensors act in a contactless manner. Preferably, the sensors act optically, for example by means of laser technology, and/or acoustically, for example by means of ultrasound and/or by means of radar. The sensors can concern in particular sensors which enable a contactless monitoring by means of ultrasound or laser technology. The sensors can be lidar sensors. The sensors can be laser scanners. They can emit and detect invisible light, for instance in the infrared range. When the sensors, alternatively or additionally to invisible light, emit and detect visible light, a deterrence can be achieved, and the preventive effect of the monitoring system can be increased.

Preferably, the vehicle comprises a sensor evaluation device, preferably operatively connected to the sensors, by means of which a differentiation can be made between objects which move past the vehicle and those which damage the vehicle.

By a corresponding evaluation of the sensor data, differentiation can be reliably made between objects which move past the vehicle and those which damage the vehicle.

The activation device is preferably operatively connected to the monitoring sensors or respectively to the sensor evaluation device. The cameras can concern cameras which are fastened on the vehicle, or cameras which are not fastened on the vehicle. The vehicle or respectively the monitoring system can comprise an alarm arrangement for the emitting of an audible acoustic alarm and/or of a silent alarm. Preferably, the activation device is operatively connected to the alarm arrangement. Alternatively or additionally, an alarm arrangement can be provided which is not comprised by the vehicle. The activation device can be set up to cooperate with an alarm arrangement which is not comprised by the vehicle. When the sensors detect a body in the detection zone, various measures can be undertaken. For example, external cameras, or also cameras which are fastened directly on the vehicle, can be switched on in order to retain or respectively record the process. Alternatively or additionally, for example an audible acoustic alarm or a silent alarm can be emitted, or lighting can be switched on.

The monitoring system can form, by means of the sensors, a protective field at least partially around the outer shell of the vehicle. As soon as a sensor detects an object in the protective field, the activation device can bring about the switching on of cameras and/or the emitting of an audible acoustic alarm or a silent alarm and/or the switching on of a lighting.

In an embodiment, the monitoring sensors are in operation exclusively outside the operating times of the vehicle. In this embodiment, the monitoring sensors serve preferably exclusively for the prevention and/or reconnaissance of vandalism. In another embodiment, the monitoring sensors are in operation outside and during the operating times of the vehicle. When the monitoring sensors are in operation outside and during the operating times of the vehicle, they are preferably sensors which are used in a multiple manner. Preferably they are then used by the monitoring system outside the operating times of the vehicle and within the operating times by the interfering contour detection system. The monitoring sensors—in particular for the prevention and/or reconnaissance of vandalism—can be retrofitted sensors.

The sensors of the monitoring system are preferably arranged on the vehicle.

In an embodiment, the monitoring system at least also uses sensors of the entry system. Preferably, the monitoring system uses alternatively or additionally sensors which are installed in addition to the sensors of the entry system.

The sensors of the monitoring system preferably guarantee a non-imaging detection.

At least one or all sensors of the monitoring system preferably concern sensors which are also suitable or respectively permitted for an entry system. Recourse can therefore be made for the monitoring system to sensors which are already proven or respectively permitted for the vehicle.

The disclosure also relates to a method for monitoring a vehicle, above all for the prevention of vandalism and/or the reconnaissance of cases of vandalism. In this method, at least part of the outer shell of the vehicle is monitored by sensors. In an embodiment of the method, the method is carried out exclusively outside the operating times of the vehicle.

The method is preferably carried out by means of a monitoring system.

For the method, preferably at least one sensor is used with chronological interruptions. Preferably, for the method, at least one sensor is used which is used for another purpose in these chronological interruptions, in particular for an entry system. For the method at least one sensor is used which is used during the operating times of the vehicle also or exclusively for an entry system, as operating sensor, for detecting the position of passengers.

The individually listed features in the claims can also, across category boundaries, be combined with one another in any desired, technically expedient manner and indicate further embodiments of the disclosure. For example, features which are described in connection the vehicle can also be combined with the method. The description additionally characterizes and specifies the disclosure in particular in connection with the figures.

### BRIEF DESCRIPTION OF THE DRAWINGS

The disclosure is explained more closely with the aid of the following figures. These are to be understood as only by way of example and are not to limit the disclosure to the example embodiments which are shown.

There are shown:

FIG. 1 additionally installed sensors or respectively a schematic lateral illustration of a first example embodiment of a vehicle according to the disclosure;

FIG. 2 the use of the operating sensors used by the entry system or respectively a portion of a second example embodiment of a vehicle according to the disclosure;

FIG. 3 a view as in FIG. 1 with further details; and

FIG. 4 a view as in FIG. 2 with further details.

### DETAILED DESCRIPTION OF THE DRAWINGS

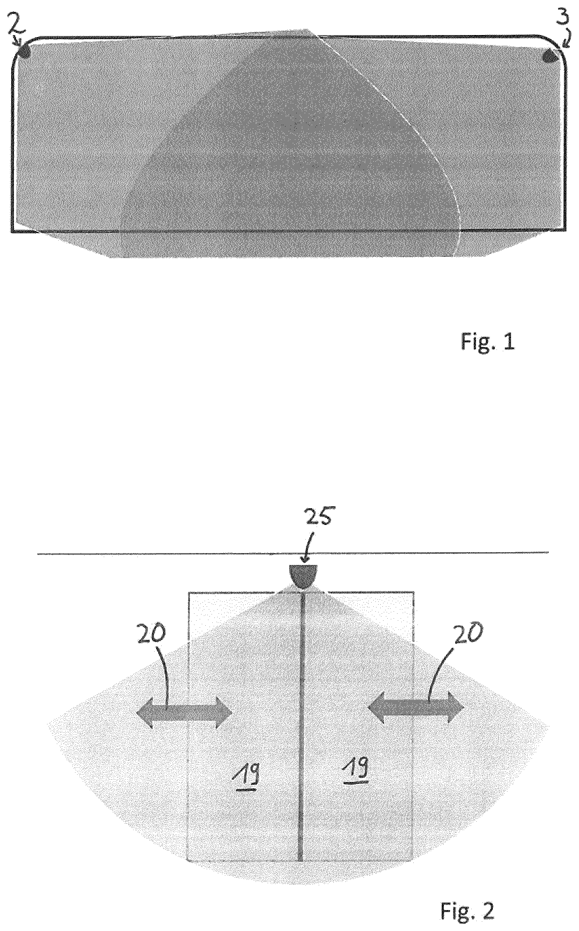

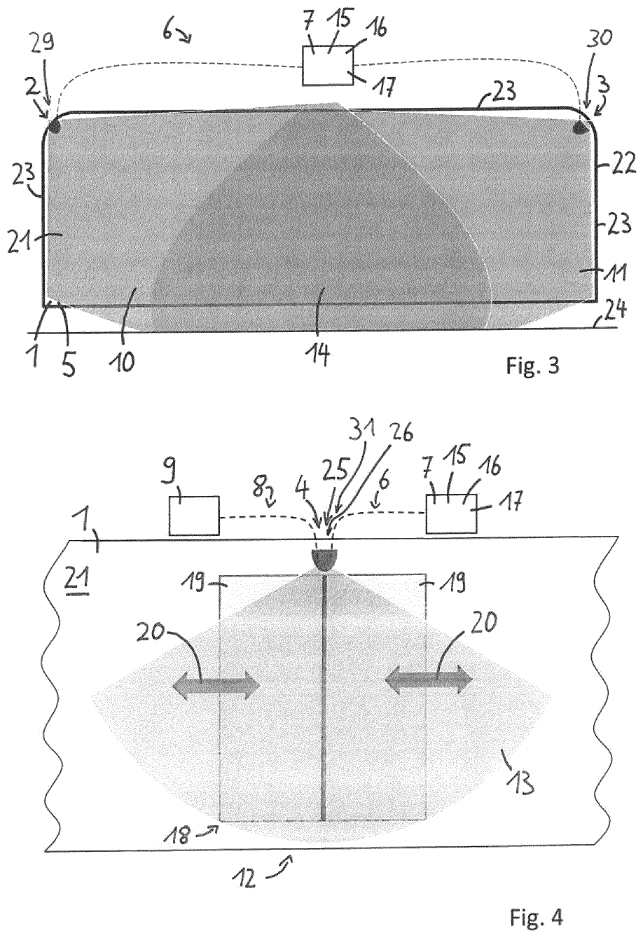

In FIGS. 1 and 3, a first example embodiment is shown, schematically from the side, of a vehicle 1 according to the disclosure, and namely a bus. The vehicle has wheels which are omitted for the sake of easier representation in the figures. The sensors 2, 3 of the vehicle 1 monitor at least part of the outer shell 5 of the vehicle 1.

Only a lateral area 21 of the outer shell 5 of the vehicle 1 is shown in the figures.

The sensors 2, 3 comprise monitoring sensors 29, 30 for the detection of vandalism, which are at least also in operation outside the operating times of the vehicle 1.

The monitoring system 6 of the vehicle 1, using the monitoring sensors 29, 30, which is in operation outside the operating times of the vehicle, prevents vandalism and serves for the reconnaissance of vandalism cases, is illustrated schematically for instance in FIG. 3. The monitoring system 6 comprises monitoring sensor electronics 7, which are set up to operate the monitoring sensors 29, 30 at least also outside the operating times of the vehicle. The monitoring system 6 comprises an activation device 16, which is set up to bring about the switching on of cameras and/or the emitting of an audible acoustic alarm or a silent alarm and/or the switching on of a lighting.

The vehicle has doors 18 (not shown in FIGS. 1 and 3), which respectively define a door region.

The monitoring sensors 29, 30 have respectively a detection zone 10, 11, which is configured so that a crawling underneath of the vehicle 1 is detected and which reaches to the ground 24 on which the vehicle 1 is standing. This serves for the protection of the charging electronics of the vehicle 1. Moreover, the detection zones 10, 11 are respectively adapted to the outer contour of the outer shell 5 of the vehicle 1 and are greater than a door region. The detection zone 10, 11 of the monitoring sensors 29, 30 also comprises respectively the door region and is adapted to the outer shell 5 or respectively to the outer contour 22 of the outer shell of the vehicle 1, by extending along two edges 23 of the lateral area 21 of the outer shell 5. The two detection zones 10, 11 shown in FIG. 3 overlap one another in an overlapping region 14 and cover the lateral area 21 of the outer shell 5 together to more than 90%. The two monitoring sensors 29, 30 shown in FIG. 3 therefore monitor the lateral area 21 of the outer shell to a proportion of more than 90%.

A further example embodiment is shown in FIGS. 2 and 4. The same reference numbers designate the same components here. In this respect, reference is to be made to the above description. The vehicle 1 of the second example embodiment likewise has the sensors 2, 3, 29, 30 of the first example embodiment (not shown in FIGS. 2 and 4). In the following, only the differences with respect to the first example embodiment shown in FIGS. 1 and 3 are presented.

Beyond the sensors shown in FIGS. 1 and 3, the vehicle of the second example embodiment has further sensors 4 in the form of operating sensors 26, which are in operation at least also during the operating times of the vehicle 1, for the detection of the position of passengers. One of these sensors 4, 26 is shown in FIGS. 2 and 4.

The vehicle 1 of the second example embodiment comprises an entry system in the form of an entry system 8. The sensor used by the entry system is an external sensor 25. Like all other sensors shown in the figures, it is arranged on the vehicle, outside the vehicle. FIG. 2 shows the two door wings 19, the door course 20 and the external sensor 25.

The operating sensor 4, 26, used by the entry system 8, is used in a multiple manner and is also a monitoring sensor 31, used by the monitoring system 6, for the detection of vandalism. The detection zone 13 of the sensor 4, 26, 31 of the monitoring system 6, also used by the entry system 8, is adapted to the respective door region 12. The entry system 8 comprises entry sensor electronics 9 which are set up to operate the sensor 4, 26, 31 of the monitoring system 6, also used by the entry system 8, in the operating times of the vehicle 1.

The monitoring system 6 of the second example embodiment of the vehicle uses the sensor 4, 26, 31, present in any case, also used by the entry system 8, and the additionally installed sensors 2, 3, 29, 30, shown in particular in FIG. 3. The sensor 4, 26, 31 shown in FIG. 4 serves, during the operating time of the vehicle 1, for the detection of the position of passengers, and serves outside the operating time of the vehicle for the detection of vandalism. As this sensor 4, 26, 31 is a sensor which is already present in any case, used by the entry system 8, its further use reduces the additional expenditure which is involved with the monitoring system 6.

All the sensors 6 shown in the figures act in a contactless manner and guarantee a non-imaging detection, and are arranged externally on the outer shell of the vehicle 1. The sensors operate optically, by means of laser technology.

The vehicles 1 of both example embodiments which are shown comprise a sensor evaluation device 15, operatively connected to the sensors 2, 3, 4, 26, 29, 30, 31, by means of which device a differentiation can be made between objects which move past the vehicle 1, and those which damage the vehicle. The activation device 16 is operatively connected to the sensor evaluation device 15. The monitoring system 6 has an alarm arrangement 17 for emitting an audible acoustic alarm and a silent alarm, which alarm arrangement is able to be activated by the activation device 16. Unlike as illustrated in the figures, the monitoring sensor electronics 7, the sensor evaluation device 15, the activation device 16 and the alarm arrangement 17 can be devices which are separate from one another.

In addition to the monitoring system 6 using the monitoring sensors 29, 30, 31, the vehicles 1 of both example embodiments have an interfering contour detection system, likewise using the monitoring sensors 29, 30, 31. Hereby, in the case of an oncoming approach of the vehicle 1, interfering contours can be detected (underground train surfers, suburban train surfers or dragged-along objects).

FIGS. 1 and 3 or respectively 2 and 4 also show two example embodiments of a monitoring system 6. The first example embodiment of the monitoring system 6 shown in FIGS. 1 and 3 comprises the two sensors 2, 3, 29, 30 shown in FIGS. 1 and 3, which monitor part of the outer shell 5 of the vehicle 1. In the second example embodiment of the monitoring system 6 shown in FIGS. 2 and 4, the monitoring system 6 uses, in addition to the two sensors 2, 3, 29, 30 shown in FIGS. 1 and 3, also the sensor 4, 26, 31 of the BMU 8 shown in FIGS. 2 and 4.

FIGS. 1 to 4 also show an example embodiment of the method. In this method for monitoring the vehicle 1, part of the outer shell 5 of the vehicle 1 is monitored with sensors 2, 3, 4, 29, 30, 31, and by means of the monitoring system 6 at least also outside the operating times of the vehicle 1.

1.-18. (canceled)

19. A vehicle with sensors, which monitor at least part of the outer shell of the vehicle, wherein
the sensors comprise monitoring sensors for the detection of vandalism, and the vehicle comprises a monitoring system using the monitoring sensors and the monitoring system comprises monitoring sensor electronics which are set up to operate the monitoring sensors at least also in the parked state of the vehicle,
and the vehicle comprises automatically closing doors and the sensors comprise operating sensors for detecting the position of passengers, and the vehicle has an entry system using the operating sensors, which serves to detect the position of passengers, in order to prevent a jamming of passengers during the automatic closing of the doors,
wherein at least one sensor is configured both as operating sensor and also as monitoring sensor and is used both by the monitoring system and also by the entry system.

20. The vehicle according to claim 19, wherein the monitoring system comprises an activation device, which can bring about the switching on of cameras and/or the emitting of an audible acoustic alarm or a silent alarm and/or the switching on of a lighting.

21. The vehicle according to claim 19, wherein the monitoring sensors have a detection zone, which is adapted to the outer contour of the outer shell of the vehicle.

22. The vehicle according to claim 19, wherein the monitoring sensors have a detection zone, which is configured so that a crawling underneath of the vehicle is detected.

23. The vehicle according to claim 19, wherein the vehicle is a bus with electric drive, and comprises a drive battery chargeable in a contactless manner by means of charging electronics, and the monitoring sensors serve to protect the charging electronics.

24. The vehicle according to claim 19, wherein the vehicle comprises an interfering contour detection system using the monitoring sensors.

25. The vehicle according to claim 19, wherein the sensors are arranged externally on the outer shell of the vehicle.

26. The vehicle according to claim 19, wherein the sensors act by radar and/or optically.

27. A method for monitoring a vehicle, above all for the prevention of vandalism and/or for the reconnaissance of cases of vandalism, wherein at least part of the outer shell of the vehicle is monitored by sensors, wherein the outer shell is at least also monitored outside the operating times of the vehicle, wherein the vehicle comprises automatically closing doors and an entry system and for the method at least one sensor is used, which during the operating times of the vehicle is also or exclusively used for the entry system as operating sensor, for detecting the position of passengers.

28. The method according to claim 27, wherein for the at least partial monitoring of the outer shell of the vehicle, operating sensors and additionally installed monitoring sensors are used.
